(19) United States
(12) Patent Application Publication
(10) Pub. No.: US 2026/0349301 A1
(43) Pub. Date: Nov. 5, 2026

(54) FOVEAL LIQUID CRYSTAL LENSES FOR AR GLASSES

(71) Applicant: Goertek Electronics Inc., Santa Clara, CA (US)

(72) Inventors: Kun GAO, Dublin, CA (US); Yi ZHANG, Mountain View, CA (US)

(73) Assignee: Goertek Electronics Inc., Santa Clara, CA (US)

(21) Appl. No.: 19/195,624

(22) Filed: Apr. 30, 2025

(51) Int. Cl. G02F 1/1343; G02B 27/01; G02C 7/08

(52) U.S. Cl. CPC G02F 1/134336; G02B 27/0172; G02C 7/086; G02F 1/13439; G02B 2027/0178; G02B 2027/0187

(57) ABSTRACT

A liquid crystal (LC) device includes a first structure including: a first conductive layer including first control electrodes disposed on a first substrate, a dielectric layer disposed on the first conductive layer, and a plurality of electrode structures disposed on the dielectric layer. Each electrode structure includes (i) a first contact point electrically coupled with a respective first control electrode of the first control electrodes and (ii) a second contact point electrically coupled with a respective second control electrode that is disposed over the dielectric layer. The LC device includes an LC material between the plurality of electrode structures and a second conductive layer disposed between a second substrate and the first structure. An LC lens is formed when a first voltage is applied between the first control electrode and the second conductive layer, and a second voltage is applied between the second control electrode and the second conductive layer.

### TECHNICAL FIELD

The present disclosure includes aspects related to display technology, such as near eye display technology based on liquid crystal.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Near eye display (NED) devices are developed to provide an improved user experience in fields such as prescription corrections, extended reality (XR), such as augmented reality (AR), virtual reality (VR), mixed reality (MR), and/or the like. The NED devices can include various wearable devices, such as a head mounted display (HMD) device, smart glasses, and the like.

### SUMMARY

Aspects of the disclosure provide a liquid crystal (LC) device. The LC device includes a first LC structure matrix. The first LC structure matrix includes a first substrate and a first structure. The first structure includes a first conductive layer disposed on the first substrate, a dielectric layer disposed on the first conductive layer, and a plurality of electrode structures disposed on the dielectric layer. The first conductive layer is transparent and includes first control electrodes. Each of the plurality of electrode structures includes (i) a first contact point that is electrically coupled with a respective first control electrode of the first control electrodes and (ii) a second contact point that is electrically coupled with a respective second control electrode that is disposed over the dielectric layer. The first LC structure matrix includes an LC layer including an LC material between the plurality of electrode structures of the first structure and a second conductive layer that is disposed between a second substrate of the first LC structure matrix and the first structure. A first LC lens corresponding to a first one of the plurality of electrode structures is formed when a first voltage is applied between (i) the first control electrode that is electrically coupled with the first contact point of the first one of the plurality of electrode structures and (ii) the second conductive layer, and a second voltage is applied between (i) the second control electrode that is electrically coupled with the second contact point of the first one of the plurality of electrode structures and (ii) the second conductive layer.

Aspects of the disclosure provide a head mounted display (HMD) system. The HMD system includes a sensor configured to detect information indicating a gaze direction of an eye of a user of the HMD system, a processor configured to determine the gaze direction based on the information detected by the sensor, a plurality of liquid crystal (LC) devices, and a controller. Each of the plurality of LC devices includes: a first substrate, a first structure, and an LC layer including an LC material between a plurality of electrode structures of the first structure and a second conductive layer that is disposed between a second substrate of the LC device and the first structure. The first structure includes a first conductive layer disposed on the first substrate, a dielectric layer disposed on the first conductive layer, and the plurality of electrode structures disposed on the dielectric layer. The first conductive layer is transparent and includes first control electrodes. Each of the plurality of electrode structures includes (i) a first contact point that is electrically coupled with a respective first control electrode of the first control electrodes and (ii) a second contact point that is electrically coupled with a respective second control electrode that is disposed over the dielectric layer. An LC lens corresponding to one of the plurality of electrode structures is formed when a first voltage is applied between (i) the first control electrode that is electrically coupled with the first contact point of the one of the plurality of electrode structures and (ii) the second conductive layer, and a second voltage is applied between (i) the second control electrode that is electrically coupled with the second contact point of the one of the plurality of electrode structures and (ii) the second conductive layer.

### BRIEF DESCRIPTION OF THE DRAWINGS

Further features, the nature, and various advantages of the disclosed subject matter will be more apparent from the following detailed description and the accompanying drawings in which:

FIG. 1 shows an example of a liquid crystal (LC) lens that is electrically tunable according to an aspect of the disclosure;

FIG. 2 shows a refractive index of the LC lens versus a position on a substrate according to an aspect of the disclosure;

FIGS. 3-4 show examples of different visions depending on an angle between a gaze direction and a direction from which light may come into an eye according to an aspect of the disclosure;

FIG. 5 shows an example of a matrix of tunable liquid crystal lens (TLCL) structures according to an aspect of the disclosure;

FIGS. 6A-6B show an example of a portion of the TLCL structure in top view and in cross-sectional view, respectively;

FIGS. 7A-7B show optical path lengths of a LC lens versus a position along an axis that goes through a center of an electrode structure of the TLCL structure according to an aspect of the disclosure;

FIG. 8 shows an example of a crosstalk that is caused by an active area to one or more adjacent regions of the active area according to an aspect of the disclosure;

FIGS. 9 and 10A-10B show an example of a TLCL matrix including TLCL structures according to an aspect of the disclosure;

FIG. 11 shows an example of a multi-cell structure that includes two TLCL matrices according to an aspect of the disclosure;

FIG. 12 shows an example of an LC Rx glasses including a TLCL matrix according to an aspect of the disclosure; and

FIG. 13 shows an example of a portion of an AR glass including a TLCL matrix according to an aspect of the disclosure.

### DETAILED DESCRIPTION OF EMBODIMENTS

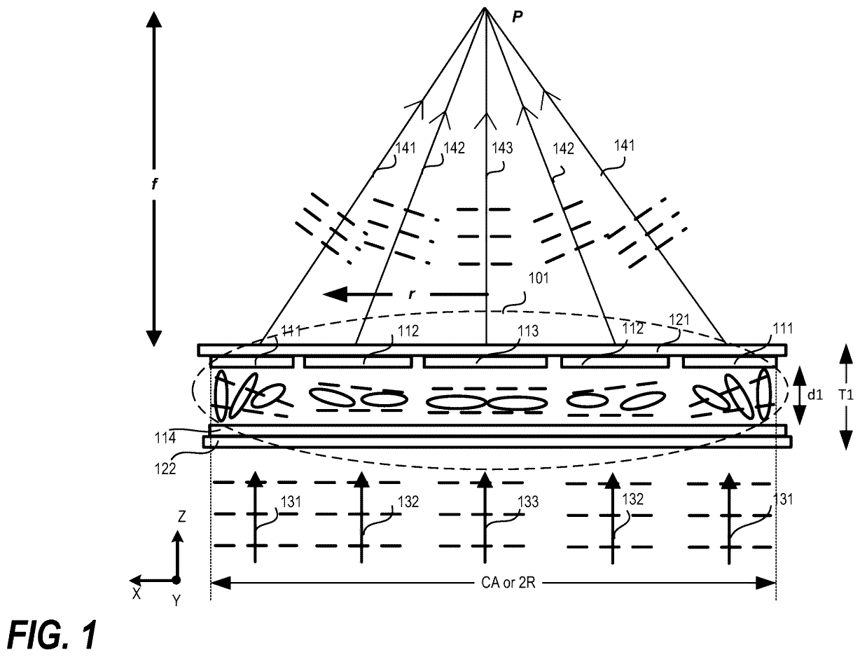

FIG. 1 shows an example of a LC lens (101) that is electrically tunable. The LC lens (101) can be referred to as an electrically tunable liquid crystal lens (TLCL). In an example, the LC lens (101) is a gradient refractive index (GRIN) lens if the LC lens (101) is based on a gradual variation of the refractive index. The LC lens (101) can correct for various vision impairments such as nearsightedness (e.g., myopia), farsightedness (e.g., hyperopia), astigmatism, coma, and/or the like.

The LC lens (101) can include an electrode structure. The electrode structure can include a plurality of electrodes. For example, the LC lens (101) can include an electrode (e.g., a circular center electrode) (113) and one or more ring electrodes (111)-(112) disposed on a first substrate (121) and an electrode (114) disposed on a second substrate (122). In the example shown in FIG. 1, the plurality of electrodes (e.g., including the electrodes (111)-(113)) are electrically isolated from each other.

The first substrate (121) and the second substrate (122) can be parallel to each other, for example, parallel to the XY plane. The first substrate (121), the second substrate (122), and the electrodes (111)-(114) can be transparent. The first substrate (121) and the second substrate (122) can be flat, and thus the LC lens (101) can be flat. A thickness T1 of the LC lens (101) can be relatively small, such as less than or equal to 1 mm. The electrodes (111)-(114) can be controlled by a voltage controller, and voltages can be applied via bus lines).

The LC lens (101) can include a plurality of LC cells. Each LC cell can include a stack of (i) a transparent substrate (e.g., a glass substrate) such as the second substrate (122), (ii) a transparent electrode (e.g., indium tin oxide (ITO), such as (114)), (iii) an alignment material (e.g., polyimide) to align the LC material, (iv), an LC material (e.g., nematic LC material), (v) a transparent electrode (e.g., ITO, such as (113)), and (vi) a transparent substrate (e.g., (121)). In an example, the nematic LC material does not twist along a light path.

In an aspect, multiple voltages are applied to the respective electrodes (111)-(113) with reference to the electrode (114). In an example, the electrode (114) is a ground. A first voltage is applied between the electrode (111) and the electrode (114), a second voltage is applied between the electrode (112) and the electrode (114), and a third voltage is applied between the electrode (113) and the electrode (114). In an example, the electrode (111) is at an edge of the LC lens (101), and the first voltage is the largest of the multiple voltages, such as 6V. The electrode (113) is at a center of the LC lens (101), and the third voltage is the smallest of the multiple voltages, such as OV. In an example (not shown), no electrode is formed at the center of the LC lens (101), and thus the third voltage can be OV.

When the multiple voltages are applied between respective electrodes (111)-(113) and the electrode (114), respectively, the LC materials (indicated by ovals in FIG. 1) between the respective electrodes (111)-(113) and the electrode (114) can be manipulated differently. For example, orientations of respective directors of the LC materials change in different apertures (e.g., corresponding to the electrodes (111)-(113)) of the LC lens (101), Thus, refractive indices, such as a first refractive index n1, a second refractive index n2, and a third refractive index n3 corresponding to the respective electrodes (111)-(113), can be different. In an example, the LC materials are birefringent and have two refractive indices nₑ and nₒ for extraordinary and ordinary light rays, respectively. The first refractive index n1 at the edge (e.g., corresponding to (111)) of the LC lens (101) can be the smallest (e.g., nₒ), and the third refractive index n3 at the center (e.g., corresponding to (113)) of the LC lens (101) can be the largest (e.g., nₑ).

FIG. 1 shows an example having two ring electrodes (112)-(113). However, the number of the one or more ring electrodes can be any positive integer, such as 1, 2, or larger than 2.

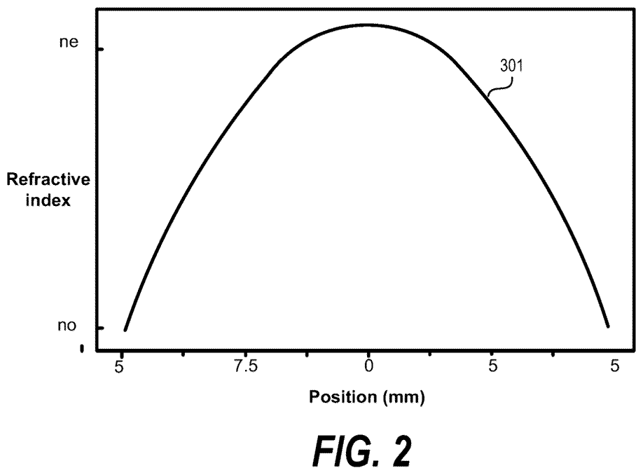

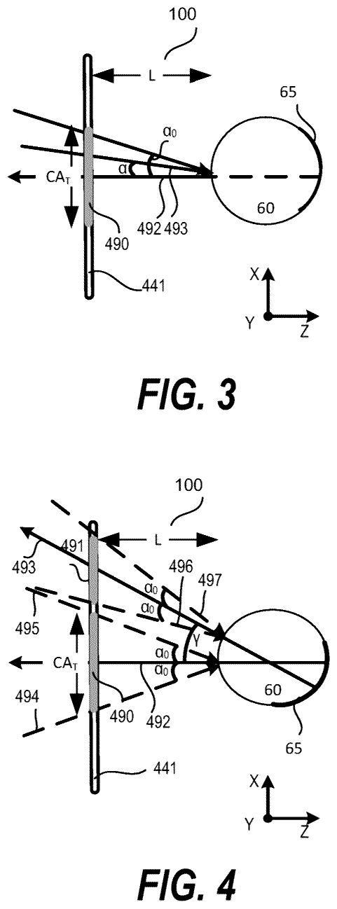

FIG. 2 shows a refractive index of the LC lens (101) versus a position on the first substrate (121). A position of 0 mm is at a center of the first substrate (121). When the number of the one or more ring electrodes is a relatively large number, a profile (301) indicating the refractive index of the LC lens (101) versus the position can be relatively smooth. Referring to FIGS. 1 and 3, the refractive index of the LC lens (101) can vary with a radial distance r (e.g., an absolute value of the position) from the center of the first substrate (121). The refractive index can be controlled by the respective voltages of the electrodes (111)-(113). The refractive index can be circularly symmetric in the XY plane.

Referring to FIG. 1, a light beam (e.g., linearly polarized) can be incident onto the LC lens (101) along a direction indicated by arrows (131)-(133). The light beam can include a center portion (e.g., associated with the arrow (133)) that passes through the electrode (113) and peripheral portions (e.g., associated with the arrows (131)-(132)) that pass through the electrodes (111)-(112), respectively. Dashed lines associated with the arrows (131)-(133) can represent wavefronts of the center portion and the peripheral portions of the light beam, respectively. Due to the refractive index variation with the position shown in FIG. 1, wavefronts of the light beam within the LC lens (101) and wavefronts of the light beam exiting the LC lens (101) can be tilted as indicated by dashed lines within and outside the LC lens (101), respectively. Thus, a center portion and peripheral portions of the output light beam can be focused on a same focal point P with a focal length f, for example, measured as a distance between the focal point P and the first substrate (121). In an example, directions of the center portion and the peripheral portions of the output light beam are represented by arrows (143) and (141)-(142), respectively. The LC lens (101) can be equivalent to a lens (e.g., a convex lens) made from glass.

As shown in FIG. 3, the profile (301) indicating the refractive index of the LC lens (101) can be aspheric, such as parabolic, in a cross section (e.g., an XY plane) through a principal axis (e.g., Y-axis) when the multiple voltages are applied. A phase and an optical path length (OPL) (or an optical path (OP)) of a light beam in a material can be proportional to the refractive index and a distance traveled in the material. A first phase and a first OP of the light beam in the LC lens (101) can be proportional to the refractive index and a distance d, and thus a first phase profile or a first OPL profile can have an identical shape as that of the profile (301), such as aspheric (e.g., parabolic) in the cross section (e.g., the XY plane) through the principal axis (e.g., Y-axis) when the multiple voltages are applied as shown in FIG. 2. d1 can be a distance between the electrodes (111)-(113) and the electrode (114). In an example, d1 is referred to as a cell gap. d1 can be a thickness of the LC lens (101) that does not include the first and the second substrates (121)-(122). A parabolic phase profile can perform better than a spherical profile when a light beam emitted by a point source is collimated by the LC lens (101) or a collimated light beam is focused by the LC lens (101). A first optical path difference (OPD), for example, between the first OP associated with a position on the first substrate (121) and a first reference OP associated with a reference position (e.g., at the edge on the first substrate (121)) can have a same shape as that of the profile (301) in FIG. 2 where the first OP and the first reference OP are in the LC lens (101). In an example, the first OPD between the first OP at the center position (e.g., 0 mm) and the first OP at the edge position is proportional to (nₑ−nₒ)×d.

A second OPD between a second OP associated with a position on the first substrate (121) and a second reference OP associated with a reference position on the first substrate (121) has a parabolic shape where the second OP and the second reference OP are between the LC lens (101) and the focal point P. In an example, the second OPD is estimated using Eq. 1 where r indicates the radial distance.

$$Second OPD = \sqrt{{r}^{2} + {f}^{2}} - f \approx \frac{{r}^{2}}{2 f} \qquad Eq . 1$$

In an example, a total OP that is a sum of the first OP in the LC lens (101) and the second OP from the LC lens (101) to the focal point P is the same or similar for each position on the first substrate (121), and thus different portions of the light beam can be focused onto the same focal point P.

In an example, a theoretical limit of an optical power for the LC lens (101) (e.g., a GRIN lens) can be derived based on Eq. 2.

Optical power=2×Δn×d1/R2 Eq. 2

where R is a radius of the LC lens (101) that is used (e.g., is activated by applying suitable voltages to the LC lens (101)) to converge or diverge light, the optical power (e.g., unit of diopter in m⁻¹) can be an inverse of the focal length f, Δn is equal to (nₑ−nₒ) indicating the birefringence of the LC materials. In an example, a diameter (e.g., 2R) is referred as to a clear aperture (CA) of the LC lens (101). The radial distance r in Eq. 1 can range from 0 to R. In an example, the refractive index of the LC lens (101) at the edge (e.g., r=R) is nₑ, the refractive index of the LC lens (101) at the center (e.g., r=0) is nₒ. The CA of the LC lens (101) can depend on the arrangement of the electrodes of the LC lens (101) and how voltages are applied to the electrodes. Referring to FIG. 1, the CA can be equal to or approximately equal to an outer diameter of the ring electrode (111) when suitable voltages are applied such that the area covered by the electrodes (111)-(113) is activated to converge or diverge light. By reversing polarities of voltages, the LC lens (101) can become a diverging lens having the same magnitude of diopter (e.g., −1D). By adjusting the multiple voltages, a continuous varifocal manipulation between the strongest positive optical power (e.g., +1D) and the strongest negative optical power (e.g., −1D) can be achieved.

In an example, the LC materials in the LC lens (101) include rodlike molecules exhibiting positive birefringence, nₑ is from 1.56 to 1.89, nₒ is from 1.47 to 1.55, An is from 0.05 to 0.45, d1 is from 10 to 50 microns, R is from 1 mm to 50 mm (e.g., R is approximately 5 mm) and voltages are less than or equal to 10 V. The electrodes (111)-(114) can be made from ITO. The first and second substrates can be made from glass, plastics, and/or any suitable material(s). In an example, the first and second substrates are glass substrates with a total thickness of 0.5 mm, and thus T1 can be from 0.5 mm to 0.8 mm. Additional material(s) (e.g., an alignment layer) may be used in the LC lens (101).

Referring to FIG. 3, human vision may be classified into different visions depending on an angle α between a gaze direction (492) and a direction (493) from which light may come into an eye (60). In an aspect, human vision can include foveal vision (e.g., a sharp, detailed vision) and peripheral vision (e.g., a vision that is blurrier than the foveal vision). In an example, the foveal vision is at a center region of a visual field and corresponds to, for example, the angle α being less than or equal to a threshold angle α0. Light can be focused on the fovea, a small area in a center of a retina (65) responsible for high visual acuity, allowing a person to see fine details and colors. In an example, the peripheral vision is at a peripheral region of the visual field and corresponds to, for example, the angle α being larger than the threshold angle α₀. The peripheral vision corresponds to the visual field outside the fovea, and has a lower resolution than the resolution of the foveal vision. In an example, the threshold angle α₀ is 9° or is approximately 9°.

As shown in Eq. 2, when CA increases, the optical power of the lens (101) can decrease. On the other hand, when CA increases, a field of view can increase. Thus, a value of the CA can be determined based on requirements for the optical power, the field of view, and/or the like.

In an example, the value of the CA (e.g., an area or a diameter of the LC lens) is determined (e.g., selected) based on the kind of human vision (e.g., the foveal vision). For example, light within the angle α₀ may be used and thus may be collected in forming images on the retina (65) of the eye (60), and light outside the angle α₀ may not need to be used in forming images on the retina (65) of the eye (60). Referring to FIG. 3, a threshold size CA_{T} can be determined based on the angle α₀ (e.g., 9° for the foveal vision) and a distance L between the eye (60) and the LC lens (e.g., (490)), for example, CA_{T}=2×L×tan(α₀). In an example, L is 15 mm, and CA_{T} is approximately 4.9 mm (or 5 mm) and thus the diameter or CA of the LC lens can be at least CA_{T}.

For applications such as vision correction and/or extended reality (XR) which may refer to Augmented Reality (AR), Virtual Reality (VR), and Mixed Reality (MR), or the like, a user may wear a pair of glasses including an LC lens. Referring to FIG. 3, the glass (441) includes an LC lens (490). A distance L of the glass (441) from the eye (60) can be referred to as an eye relief. In an example, the distance of the glass (441) from the eye (60) is the same as the distance of the lens (490) from the eye (60). The eye relief L can be approximately between 12 mm and 17 mm, such as 15 mm. As described above, the CA of the LC lens (490) positioned on the glass (441) for foveal vision may depend on the eye relief L and the threshold angle α₀ for the foveal vision. In an example, the CA indicates an active area of the LC lens (490) that can diverge or converge light. In an example, CA is at least CA_{T} which is approximately 5 mm when L is 15 mm and α₀ is 9°.

A gaze direction of the eye can change. When the gaze direction changes substantially, certain light beams that are within the foveal vision of the eye may not be captured by the lens (490), as shown in FIGS. 3-4. Referring to FIGS. 3-4, a gaze direction of the eye is changed from a gaze direction (492) to another gaze direction (493). Referring to FIG. 4, the gaze direction (493) can form an angle γ with the gaze direction (492). In order for the eye (60) to have the same vision (e.g., the foveal vision) associated with the same angle α₀, light beams from a cone between light beams (496)-(497) are to enter the eye (60). The LC lens (490) is positioned within a cone between light beams (494)-(495), and is outside or is approximately outside the cone between the light beams (496)-(497). Thus, the LC lens (490) may not be suitable when the gaze direction is substantially different from that of the gaze direction (492).

In some examples, a size of an active area of an LC lens is increased to accommodate for a larger visual field, a change of a gaze direction, and/or the like. However, as described in detail above (e.g., FIGS. 1 and 2 and Eq. 2), in some examples, the size (e.g., CA) of the LC lens may depend on parameters of the LC lens, such as an optical power of the LC lens, and/or the like. In an example, a magnitude of the optical power of the LC lens decreases when the diameter of the LC lens increases.

According to an aspect of the disclosure, an LC lens device including a plurality of LC lens structures (also referred to as a plurality of TLCL structures) can be formed on a surface of a substrate, such as an eyepiece, an AR glass, or the like. T Different TLCL structures in the plurality of TLCL structures can be activated or configured as LC lenses at different positions, for example, depending on a gaze direction of an eye and which one or more TLCL structures are activated. Thus, for a given gaze direction, a corresponding TLCL lens is activated or formed to direct light beams within the foveal vision into the eye.

When a first gaze direction (e.g., (492)) is determined, a first lens structure in the plurality of LC lens structures can be configured as a first lens (e.g., (490)). In an example, the first lens structure (and the first lens (490)) spatially corresponds to the first gaze direction, for example, the first gaze direction intercepts a center region of the first lens structure (and the first lens (490)). For example, the first LC lens (490) is positioned at the interception of the glass (441) and the cone between the light beams (494)-(495). Referring to FIG. 4, when a second gaze direction (e.g., (493)) is determined, a second lens structure in the plurality of LC lens structures can be configured as a second lens (491). In an example, the second lens structure (and the second lens (491)) spatially corresponds to the second gaze direction (493), for example, the second gaze direction (493) intercepts a center region of the second lens structure (and the second lens (491)). For example, the second lens (491) is positioned at the interception of the glass (441) and the cone between the light beams (496)-(497). In an aspect, as the gaze direction changes, a corresponding lens structure in the plurality of LC lens structures can be activated as an LC lens, and thus the LC lens can be formed at a position that is determined based on the gaze direction. Accordingly, a position of an LC lens can change in real-time (e.g., simultaneously or with relatively small delay) and thus the LC lens can interact with the light beams, for example, in the foveal vision for vision correction and/or XR applications (e.g., an AR application) regardless of the change of the gaze direction.

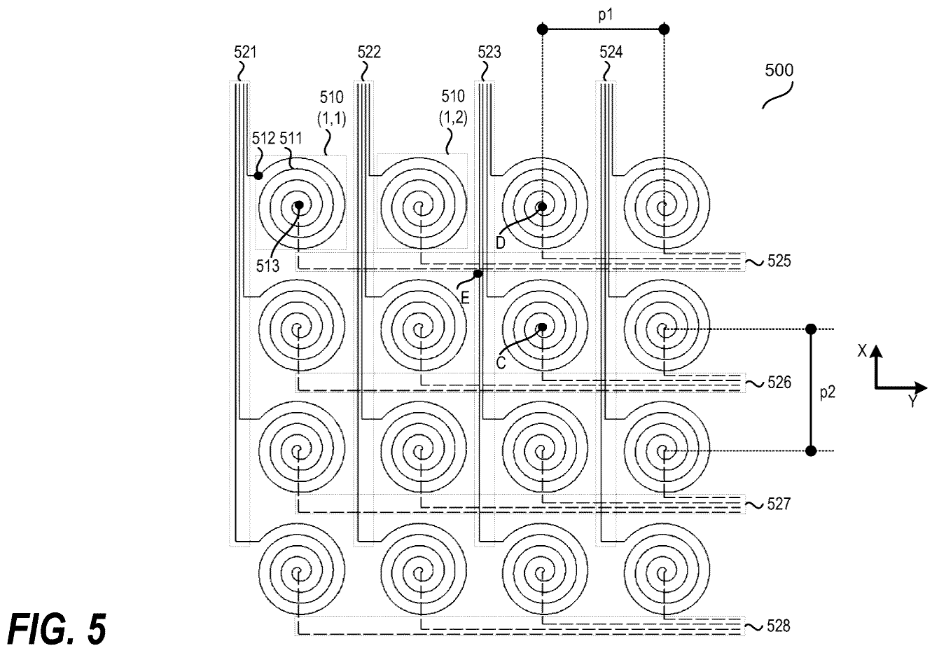

In an aspect, a plurality of TLCL structures such as a matrix of TLCL structures can be formed for a foveal vision correction field. FIG. 5 shows an example of a matrix (500) of TLCL structures according to an aspect of the disclosure. Referring to FIG. 5, the matrix (500) of TLCL structures can include multiple TLCL structures (510) arranged in a matrix on a surface, such as a surface of an AR glass, an eyepiece for vision correction, or the like. The surface can have any suitable shape. In an example, the surface is flat or substantially flat, such as an X-Y plane, and the matrix (500) is a two-dimension (2D) matrix on the flat surface. In an example, the X-Y plane is parallel or substantially parallel to a substrate of one of the TLCL structures. In an example, the surface is curved. Aspects of the disclosure are described using a flat surface, as an example, for example as shown in FIG. 5. However, aspects of the disclosure can be applied to curved surfaces.

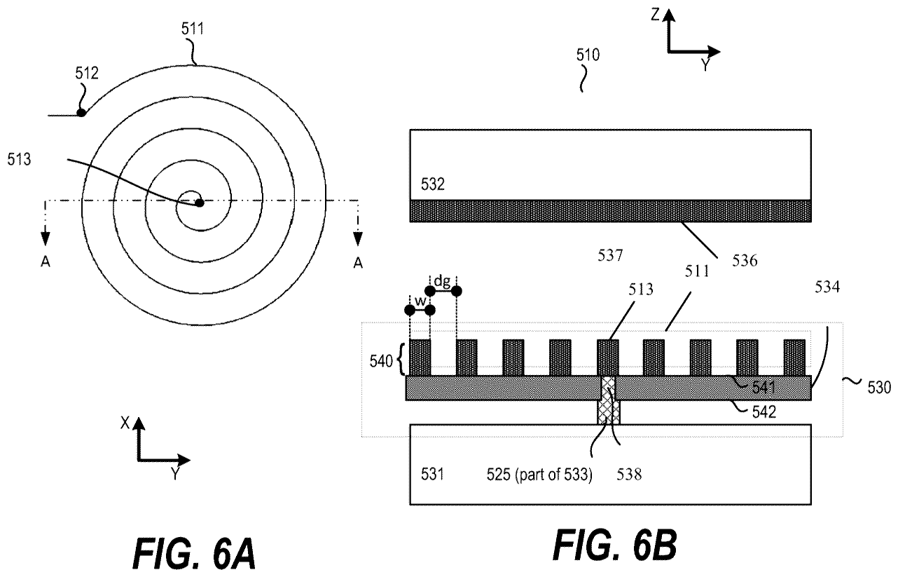

Referring to FIGS. 5 and 6A-6B, each TLCL structure (510) can be indicated by (i, j) where i and j are from 1 to 4. For example, TLCL structure (1, 1) indicates the TLCL structure position in a first column (i.e., the leftmost column in FIG. 5) and a first row (i.e., the topmost row in FIG. 5). Each TLCL structure (510) can include an LC layer (537) including LC material(s) such as nematic LC material(s) disposed between (i) an electrode structure (511) over a first substrate (531) and (ii) a conductive layer (also referred to as a second conductive layer) (536) over a second substrate (532). The LC material(s) can be manipulated by applying external voltages between different contact points (512)-(513) of the electrode structure (511) and the conductive layer (536), respectively, and thus suitable voltages are applied to different regions of the LC layer (537) similarly as described with reference to FIG. 1.

In an aspect, the contact points (512)-(513) of the respective electrode structures (511) can be electrically coupled to driver circuits using control electrodes (also referred to as bus lines). Referring to FIG. 5, the second contact points (512) of the respective electrode structures (511) can be electrically coupled to the driver circuits using the second control electrodes (or first bus lines) (521)-(524) and the like. Referring to FIG. 5, the first contact points (513) of the respective electrode structures (511) can be electrically coupled to the driver circuits using the first control electrodes (or second bus lines) (525)-(528) and the like.

In an example, the second bus lines (521)-(524) and the first bus lines (525)-(528) are perpendicular or are substantially perpendicular to each other, and thus form a grid of bus lines such that applying voltages to drive an individual TLCL structure can be relatively simple. For example, the second bus lines (521)-(524) are parallel or are substantially parallel to the X axis, and the first bus lines (525)-(528) are parallel or are substantially parallel to the Y axis.

The second bus lines (521)-(524) and the first bus lines (525)-(528) can be disposed on different conductive layers, for example, on different sides of a dielectric layer (534) shown in FIG. 6B. In an example shown in FIGS. 5 and 6B, the second bus lines (521)-(524) and the electrical structures (511) (solid lines in FIG. 5) are disposed above the dielectric layer (534), and the first bus lines (525)-(528) are disposed on a conductive layer (533) that is below the dielectric layer (534).

The second bus lines (521)-(524) and the electrical structures (511) can include different or same conductive materials. In an example, the second bus lines (521)-(524) and the electrical structures (511) include ITO, and are disposed on a same conductive layer (540) (e.g., an ITO layer) as shown in FIG. 6B. In an example, the electrical structures (511) can include ITO. In an example, the second bus lines (521)-(524) include one or more metals such as aluminum (Al), molybdenum (Mo), nickel (Ni), a combination of multiple metal materials, or the like. In an example, the second bus lines (521)-(524) including one or more metals are disposed over an ITO layer including the electrical structures (511).

When one or more first voltages are applied to the contact points (512)-(513) of a first TLCL structure (e.g., (1, 1) in FIG. 5) in the matrix (500) of TLCL structures, the first TLCL structure in the matrix (500) can be configured as a first TLCL. When one or more second voltages are applied to the contact points (512)-(513) of a second TLCL structure (e.g., (1, 2) in FIG. 5) in the matrix (500) of TLCL structures, the second TLCL structure in the matrix (500) can be configured as a second TLCL. Thus, the matrix (500) of TLCL structures can also be referred to as a TLCL matrix.

FIG. 5 shows an example of the TLCL matrix including 16 TLCL structures corresponding to 16 TLCL lens. The TLCL matrix (500) can include more than 16 TLCL structures or less than 16 TLCL structures. In aspects of the disclosure, the number of rows of TLCL structures can be equal to or different from the number of columns of TLCL structures. In an example, the plurality of TLCL structures can be disposed in any suitable arrangement over a surface (a planar surface, a curved surface, or the like) including a matrix arrangement, a concentric arrangement, or the like.

FIGS. 6A-6B show an example of a portion of the TLCL structure (510) in top view and in cross-sectional view, respectively. The TLCL structure (510) can include the first substrate (531), a first structure (530), the LC layer (537) including the LC material(s), the second conductive layer (536), and the second substrate (532).

The first structure (530) can include the conductive layer (also referred to as a first conductive layer) (533) disposed on the first substrate (531), the dielectric layer (534) disposed over the first conductive layer (533), and the electrode structure (511) that is part of the conductive layer (540). The conductive layer (540) is disposed on the dielectric layer (534). The electrode structure (511) can include the first contact point (513) and the second contact point (512). The second contact point (512) can be electrically coupled with the second control electrode (521) that is disposed over the dielectric layer (534). Referring to FIGS. 5 and 6B, the first conductive layer (533) includes the first control electrodes (525)-(528). The first contact point (513) can be electrically coupled with the first control electrode (e.g., (525)) of the first control electrodes (525)-(528). In an example, the electrode structure (511) and the first conductive layer (533) that includes the first control electrodes (525)-(528) are disposed on different sides (541)-(542) of the dielectric layer (534). The first contact point (513) of the electrode structure (511) can be electrically coupled with the first control electrode (525) through one or more conductive materials disposed in a via (538) in the dielectric layer (534).

The dielectric layer (534) can include dielectric or insulating materials, such as silicon nitride, silicon oxide, silicon carbide, and/or the like.

The first conductive layer (533) can include a metal layer including Al, Mo, Ni, a combination of multiple metal materials (e.g., an alloy), or the like. In an example, a thickness of the first conductive layer (533) is determined based on various factors such as a transmittance, a conductance, and/or the like of the conductive layer. Transmittance or transmissivity of a layer, such as the first conductive layer (533) can be defined as a ratio of transmitted optical power to the incident optical power for the layer. The first conductive layer (533) can be transparent where the transmittance of the first conductive layer (533) is less than or equal to a threshold transmittance, such as 60%, 80%, 90%, or the like.

The LC layer (537) is disposed between the electrode structure (511) of the first structure (530) and the second conductive layer (536). The second conductive layer (536) can be disposed between the second substrate (532) and the first structure (530).

The first substrate (531) and the second substrate (532) can be similar or identical to the first substrate (121) and the second substrate (122). Aspects of the first substrate (121) and the second substrate (122) can be applied to applied to the first substrate (531) and the second substrate (532), respectively.

The second conductive layer (536) can include an electrode that is similar to or same as the electrode (114) in FIG. 1. For example, the second conductive layer (536) includes indium tin oxide (ITO) such as described in FIG. 1. In an example, the second conductive layer (536) includes a uniform conductive layer that is not patterned. In an example, the second conductive layer (536) includes a patterned conductive layer.

In an example, the electrode structure (511) includes ITO such as described in FIG. 1. The electrode structure (511) can include any suitable shape, and any suitable number of contact points.

In an aspect, the electrode structure (511) has a spiral shape, and has two contact points. Referring to FIGS. 5 and 6A, the first contact point (513) of the electrode structure (511) is in a central region of the spiral shape, and the second contact point (512) of the electrode structure (511) is in a peripheral region of the spiral shape. The spiral shape shown in FIGS. 5 and 6A is referred to as a single spiral shape, for example, the spiral starts from the second contact point (512) in the peripheral region and ends at the first contact point (513) in the central region. The spiral shape shown in FIGS. 5 and 6A are circular. In some examples, the spiral shape can have other shapes, such as polygon, oval, or the like.

In an example, two external voltages can be applied to the TLCL structure (510) (e.g., (1, 1)) through the two contact points (512)-(513) with respect to a ground (via the second conductive layer (536)). For example, a first voltage Vₐ is applied between (i) the first control electrode (525) that is electrically coupled with the first contact point (513) of the electrode structure (511) and (ii) the second conductive layer (536). A second voltage V_{b} is applied between (i) the second control electrode (521) that is electrically coupled with the second contact point of (512) the electrode structure (511) and (ii) the second conductive layer (536). A first LC lens corresponding to the electrode structure (511) positioned at (1,1) can be formed when the first voltage Vₐ and the second voltage V_{b} are applied as described above.

Referring to FIG. 5, each second control electrode in the second control electrodes (e.g., (521)-(524)) can be electrically isolated from other second control electrodes in the second control electrodes (e.g., (521)-(524)). In the example shown in FIG. 5, the number of the second control electrodes (e.g., (521)-(524)) is 16. Each first control electrode in the first control electrodes (e.g., (525)-(528)) can be electrically isolated from other first control electrodes in the first control electrodes (e.g., (525)-(528)). In the example shown in FIG. 5, a number of the first control electrodes (e.g., (525)-(528)) is 16. The second control electrodes (e.g., (521)-(524)) can be electrically isolated from the first control electrodes (e.g., (525)-(528)).

Referring to FIG. 5, each electrode structure (511) can be electrically isolated from other electrode structures. Each electrode structure (511) can be configured to be driven separately from other electrode structures (511). For example, the electrode structure (2, 3) is driven separately from other electrode structures including neighboring electrode structures (1, 2), (1, 3), (1, 4), (2, 2), (2, 4), (3, 2), (3, 3), and (3, 4).

FIGS. 5 and 6A-6B show a type of electrode structures of the TLCLs matrix including M×N pixel lens (also referred to as a lens unit or a lens cell) (e.g., M and N are 4). Each pixel lens corresponding to the TLCL structure (510) can be connected by the transparent busline electrodes (e.g., (521)-(528)) with certain driving voltages. Each pixel lens can have two contact points (512)-(513). When different voltages are applied to Vₐ and V_{b} of a pixel lens, a desired OPD curve can be obtained in the lens unit, similarly as described with reference to FIGS. 1-2.

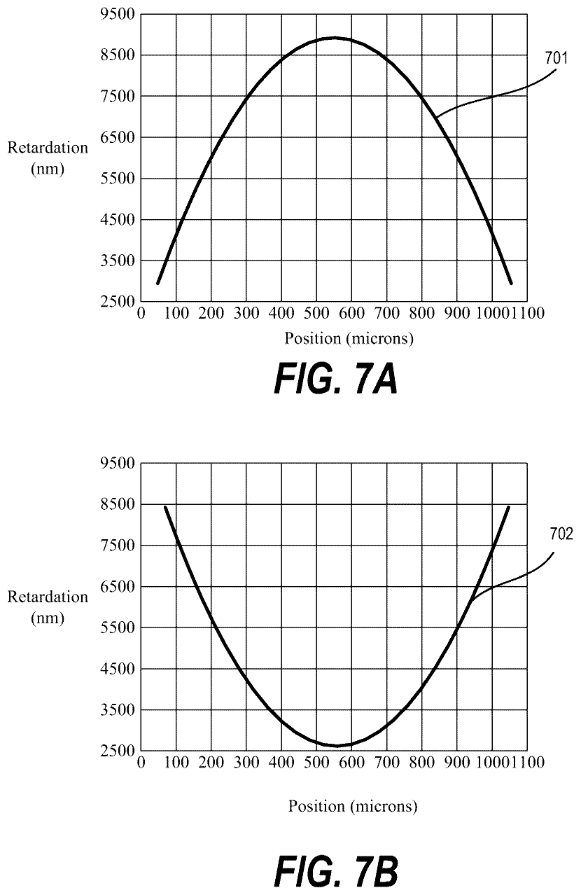

FIGS. 7A-7B show optical path lengths (or retardations) (701) and (702) of an LC lens versus a position along an axis (e.g., A-A shown in FIG. 6B) that goes through a center (e.g., the contact point (513)) of the electrode structure (511) according to an aspect of the disclosure. The optical path length (701) indicates that the LC lens formed is a positive lens. The positive lens can be formed when V_{b} which is the voltage between the contact point (512) and the conductive layer (536) is larger than Vₐ which is the voltage between the contact point (513) and the conductive layer (536). On the other hand, the optical path length (702) indicates that the LC lens formed is a negative lens. The negative lens can be formed when V_{b} is less than Vₐ. Therefore, when different voltages are applied to the pixel lens, the positive lens and the negative lens can be switched. A size of the matrix (or a number of MxN) can be determined by an actual optical aperture. In an example, each electrode structure has a diameter of approximately 5 mm or larger, and thus a size (e.g., a CA or a diameter of the active area) of the corresponding pixel lens that is formed when suitable voltages Vₐ and V_{b} are applied is approximately 5 mm which is related to the foveal vision with a sufficient field of view.

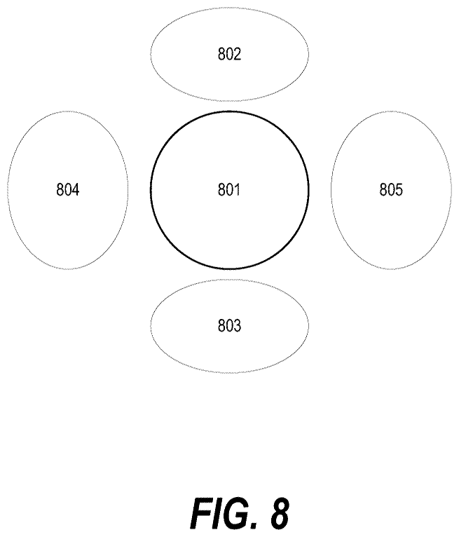

Benefits of the matrix (500) including electrically isolated electrode structures for respective TLCL structures are described below. Electrically TLCLs have attracted significant interest recently due to the small footprint and low electrical power consumption, for example. These characteristics have made electrically TLCLs well suited for wearable applications, eye-glasses or eyepieces, XR (e.g., AR, VR, or MR) headsets, and/or the like. However, in some examples of the TLCLs, there may be a conflict between a large CA and a large dynamic range of the optical power (OP) as described with reference to FIG. 1 and Eq. 2. In order to overcome this difficulty, a related TLCL design includes a serpentine electrode structure. Different parts of the serpentine electrode structure can be activated with suitable voltages, and thus different lenses can be formed having different active areas. However, in some examples, the serpentine electrode structure is a continuously conductive structure where a first part of the serpentine electrode structure is not electrically isolated from a second part of the serpentine electrode structure. The first part and the second part may be activated at different times to form lenses at different locations. In some examples, this approach using the serpentine electrode structure has problems of crosstalk that is caused by an active area (801) to one or more adjacent regions (802)-(805) of the active area (801) as shown in FIG. 8. For example, in an application, an LC lens is to be formed in the active area (801) alone and is not to be formed in the regions adjacent to the active area (801). However, in some scenarios, when an LC lens is formed in the active area (801), the voltages applied to the active area (801) can cause lens effects in the adjacent regions (802)-(805), and thus affect light beams that are incident on the adjacent regions (802)-(805) as well. This effect is referred to as the crosstalk. In some examples, the crosstalk can deteriorate the visual perception through TLCLs. In order to mitigate this problem of crosstalk, an electrode matrix structure of TLCLs such as the matrix (500) can be used.

In an aspect, the problem of crosstalk effect that is caused by the active area to the adjacent regions with the serpentine electrode structure can be solved or mitigated by using the electrode matrix structure such as shown in the matrix (500). The electro-optical TLCLs structure shown in FIGS. 5 and 6A-6B can be fabricated relatively easily as the matrix structure is relatively simple. In an aspect, the electric driving method for the matrix (500) can be simpler compared to the serpentine electrodes structure used in related technology. For example, in related technology using the serpentine electrode structure, voltages used to drive the serpentine electrodes structure have complicated phase relationships in order to form the LC lens at the active area and to reduce the cross talk between the active area (801) and the adjacent regions (802)-(805). However, the electric driving method for the matrix (500) may not need such complicated phase relationships between Vₐ and V_{b} described above. For example, referring to FIG. 5, there is nₒ (or omittable) crosstalk between the TLCL formed at the electrode structure (2, 3) and the adjacent TLCL structures when a voltage between each remaining first control electrodes and the second conductive layer (536) is zero, and voltages between each remaining second control electrodes and the second conductive layer (536) is zero. Thus, only Vₐ and V_{b} are applied to the single electrode structure (2, 3), and thus only the single electrode structure (2, 3) is electrically activated to form a single lens at that location while all other electrode structures are not activated, e.g., Vₐ and V_{b} are zero for all the other electrode structures in the matrix (500).

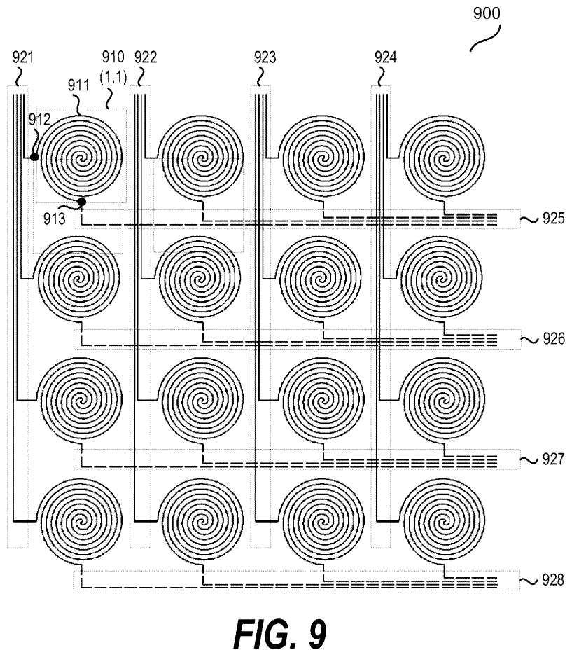

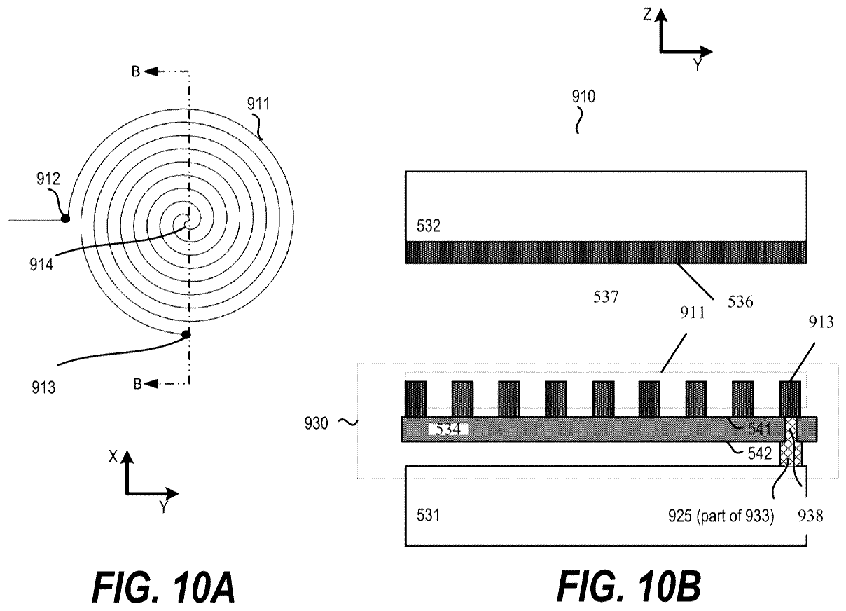

FIGS. 9 and 10A-10B show an example of a TLCL matrix (900) or a matrix (900) of TLCL structures according to an aspect of the disclosure. The matrix (900) of TLCL structures can be a variation of the matrix (500). Referring to FIG. 9, the matrix (900) of TLCL structures can include multiple TLCL structures (910) arranged in a matrix on a surface, such as a surface of an AR glass, an eyepiece for vision correction, or the like. The surface can have any suitable shape. In an example, the surface is flat or substantially flat, such as an X-Y plane, and the matrix (900) is a 2D matrix on the flat surface. In an example, the X-Y plane is parallel or substantially parallel to a substrate of one of the TLCL structures. In an example, the surface is curved. The descriptions are provided for a flat surface, as shown in FIG. 9, however, the descriptions can be suitably adapted to curved surfaces.

Referring to FIGS. 9 and 10A-10B, the matrix (900) includes TLCL structures (910), which can be a variation of the TLCL structures (510). Each TLCL structure (910) can be indicated by (i, j) where i and j are from 1 to 4, similarly as described in FIG. 5. Each TLCL structure (910) can include the LC layer (537) including the LC material(s) disposed between (i) an electrode structure (911) over the first substrate (531) and (ii) the second conductive layer (536) over the second substrate (532). The LC material(s) can be manipulated by applying external voltages to different contact points (912)-(913) of the electrode structure (911) and the conductive layer (536), and thus suitable voltages are applied to different regions of the LC layer (537) similarly as described with reference to FIGS. 1, 5, and 6A-6B.

In an aspect, the contact points (912)-(913) of the respective electrode structures (911) can be electrically coupled to driver circuits using control electrodes (or bus lines). Referring to FIG. 9, the second contact points (912) of the respective electrode structures (911) can be electrically coupled to the driver circuits using the second control electrodes (or second bus lines) (921)-(924) and the like. Referring to FIG. 9, the first contact points (913) of the respective electrode structures (911) can be electrically coupled to the driver circuits using the first control electrodes (or first bus lines) (925)-(928) and the like.

In an example, the second bus lines (921)-(924) are identical or similar to the second bus lines (521)-(524), and the first bus lines (925)-(928) are identical or similar to the first bus lines (525)-(528). Thus, aspects of the bus lines (521)-(528) can be applied to the bus lines (921)-(928), respectively, and detailed descriptions are omitted for purposes of brevity.

The electrode structure (911) is similar to the electrode structure (511) where the second contact point (912) of the electrode structure (911) is in the peripheral region of the spiral shape. The electrode structure (911) is different from the electrode structure (511) in that the first contact point (913) of the electrode structure (911) is in the peripheral region of the spiral shape. The spiral shape shown in FIGS. 9 and 10A is referred to as a double spiral shape, for example, the spiral starts from the second contact point (912) in the peripheral region, goes through a central region (914), and ends at the first contact point (913) in the peripheral region.

FIGS. 10A-10B show an example of a portion of the TLCL structure (910) in top view and in cross-sectional view, respectively. The TLCL structure (910) can include the first substrate (531), a first structure (930), the LC layer (537) including the LC material(s), the second conductive layer (536), and the second substrate (532).

The first structure (930) can include a first conductive layer (933) disposed on the first substrate (531), the dielectric layer (534) disposed over the first conductive layer (933), and the electrode structure (911) (e.g., the electrode structure (911) is part of the conductive layer (540)). The conductive layer (540) is disposed on the dielectric layer (534). The electrode structure (911) can include the first contact point (913) and the second contact point (912). The second contact point (912) can be electrically coupled with the second control electrode (921) that is disposed over the dielectric layer (534). Referring to FIGS. 9 and 10B, the first conductive layer (933) includes the first control electrodes (925)-(928). The first contact point (913) can be electrically coupled with the first control electrode (e.g., (925)) of the first control electrodes (925)-(928). In an example, the electrode structure (911) and the first conductive layer (933) that includes the first control electrodes (925)-(928) are disposed on different sides (541)-(542) of the dielectric layer (534). The first contact point (913) of the electrode structure (911) can be electrically coupled with the first control electrode (925) through one or more conductive materials disposed in a via (938) in the dielectric layer (534). In an example, the first conductive layer (933) includes similar or identical conductive material(s) as the conductive material(s) of the first conductive layer (533).

In an example, the electrode structure (911) includes ITO such as described in FIG. 1. The electrode structure (911) can include any suitable shape, and any suitable number of contact points. The spiral shape shown in FIGS. 9 and 10A are circular. In some examples, the spiral shape can have other shapes, such as polygon, oval, or the like.

The operation of the matrix (900) is similar to that of the matrix (500), and thus detailed descriptions are omitted for purposes of brevity.

The electrode structure can also include other shape(s) and/or more than two contact points. For example, the electrode structure includes multiple rings such as shown in FIG. 1, and more than two contact points such as three contact points for the electrodes 111-113, respectively. When the number of contact points of each electrode structure increases, a number of first and/or second control electrodes can increase as well.

Various parameters of the TLCL structure (510) or (910) can depend on specific applications. In some examples, a cell gap which is a thickness of the LC layer 537 ranges from 10 to 50 microns. A thickness of the dielectric layer (534) can range from 100 to 300 nm.

Thicknesses (measured along the Z axis which is perpendicular to the XY plane) of conductive layers including ITO layer(s) and metal layer(s) can depend on requirements for transmittance, conductivity (or resistivity), and/or the like. For example, increasing the thickness of a conductive ITO or metal layer can increase conductivity which is beneficial to the TLCL lenses, however, increasing the thickness can decrease the transmittance of the respective layer, which may not be desirable in some applications. Thicknesses of ITO layers such as the conductive layer 536 and the electrode structures 511 or 911 can range from 50 to 100 nanometers (nm). A thickness of the conductive layer (533) or (933) which includes the bus lines (e.g., (525)-(528) or (925)-(928)) can range from 200 to 300 nm. In an example, the bus lines (521)-(524) are formed using metal(s), and the thickness of the bus lines (521)-(524) can range from 200 to 300 nm.

Referring to FIG. 6B, a width w of the electrode structure ((511) or (911)) within the XY plane can be equal to or different from a gap distance dg between adjacent spirals of the electrode structure ((511) or (911)). In an example, w is equal or is approximately equal to dg. In an example, w is between 5 to 20 microns. In an example, dg is between 5 to 20 microns.

Referring to FIG. 5, a first distance p1 between two adjacent TLCL structures (510) along a first axis (e.g., Y axis) can range from 5 to 10 mm. A first distance p2 between two adjacent TLCL structures (510) along a second axis (e.g., X axis) can range from 5 to 10 mm. In an example, the first axis and the second axis are perpendicular or substantially perpendicular to each other. In an example, p1 is the same as p2. In an example, p1 is different from p2.

Referring to FIG. 5, a size of the TLCL structure (510) can be determined based on a size of the electrode structure (511), such as a diameter of the spiral shape. In an example, p1 is approximately 5 mm, p2 is approximately 5 mm, and the size of the TLCL structure (510) is approximately 5 mm, which matches the foveal vision of the visual field when the eye relief is approximately 15 mm. In an example, a gap between two adjacent TLCL structures (510) is much less than p1 or p2. In an example, the gap between the two adjacent TLCL structures (510) is omittable when compared with p1 or p2.

The voltages Vₐ and V_{b} can be alternating current (AC) voltages and have any suitable shape in a time domain, such as a square wave, a triangular wave, a sinusoidal wave, or the like. A frequency of Vₐ or V_{b} can range from 50 Hz to 1000 Hz. A root-mean-square (RMS) voltage of Vₐ or V_{b} can be a square root of a time average of the voltage squared. The RMS voltage of Vₐ or V_{b} can be less than or equal to 10 Volts (V). In an example, the RMS voltage of Vₐ or V_{b} is from 2 to 10 V. In an example, Vₐ is different from V_{b}.

In an example, a single TLCL is formed from a corresponding TLCL structure (510) by (i) applying Vₐ to the contact point (513) and the second conductive layer (536) of the TLCL structure (510) and (ii) applying V_{b} to the contact point (512) and the second conductive layer (536) of the TLCL structure (510). In an example, the optical power of the TLCL is from −2D to 2D for a cell gap of 20 microns, and the optical power of the TLCL is from −4D to 4D for a cell gap of 40 microns.

According to an aspect of the disclosure, which TLCL structure is selected from the TLCL structures (510) in the matrix (500) or which TLCL is formed can be determined in real time based on a gaze direction, and the activation of the selected TLCL can be implemented in real time by applying voltages to the contact points of the selected TLCL structure. Referring to FIGS. 4 and 5, in an example, the glass (441) includes the matrix (500), the gaze direction (492) intercepts the center region C of the TLCL structure (2, 3), and the gaze direction (493) intercepts the center region D of the TLCL structure (1, 3). When a gaze direction is the gaze direction (492), voltage signals can be applied to the contact points of the TLCL structure (2, 3) such that the TLCL is formed by the TLCL structure (2, 3) in the matrix (500). When the gaze direction changes from (492) to (493), voltage signals can be applied to the contact points of the TLCL structure (1, 3) such that the TLCL is formed by the TLCL structure (1, 3) in the matrix (500). Thus, which LC lens is formed on the matrix (500) may be reconfigurable electrically, and thus may be fast.

In some examples, a gaze direction may not intercept the center region of a TLCL structure (510) in the matrix (500). For example, the gaze direction intercepts a position approximately halfway between the center regions C and D, such as a region E shown in FIG. 5. In this case, the TLCL formed by the TLCL structure (1, 3) or (2, 3) is not within the foveal vision, and a user may not see clearly using the TLCL formed by the TLCL structure (1, 3) or (2, 3).

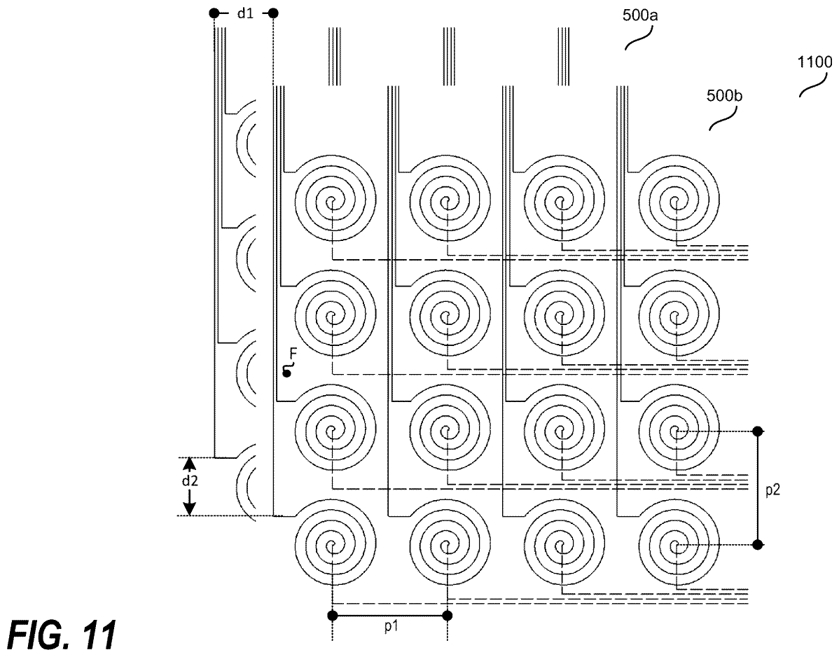

According to an aspect of the disclosure, a multi-cell structure such as a dual-cell structure can be used to cover a denser area for the foveal vision. The multi-cell structure can include multiple TLCL matrices. The multiple TLCL matrices can be a stacked along the Z axis, and adjacent TLCL matrices are shifted with respect to each other in the XY plane. FIG. 11 shows an example of a multi-cell structure (1100) that include two matrices (500a) and (500b) according to an aspect of the disclosure. Each of the matrices (500a) and (500b) can be identical or similar to the matrix (500) or (900). The matrix (500b) can be shifted with respect to the matrix (500a) along any suitable direction within the XY plane by an amount of shift. In an example, the shift direction is indicated by a first shift d1 along the Y axis and a second shift d2 along the X axis. In an example, d1 is between 0 and p1, and d2 is between 0 and p2. In an example, d1 is 0.5p1 or is approximately 0.5p1. In an example, d2 is 0.5p2 or is approximately 0.5p2.

FIG. 11 shows an example where two TLCL matrices are stacked in the multi-cell structure. The number N of TLCL matrices stacked is not limited to two. The number N of TLCL matrices stacked can be more than 2, such as 3, 4, 5, or the like. In an example, d1=p1/N, and d2=p2/N.

The multi-cell configuration can enhance the resolution and expand the gaze points area for improved eye-tracking performance. In some examples, a single TLCL matrix may not be able to achieve a desirable resolution due to size constraints. Referring to FIG. 11, in an example, one electrode structure in the matrix (500b) has a size of 5 mm, and thus a single matrix such as the matrix (500b) may provide foveal vision when the gaze direction intercepts the center region of a TLCL structure in the matrix (500b). However, the electrode structure (e.g., the electrode structure (3, 1) or (2, 1)) in the matrix (500b) may not provide the foveal vision when the gaze direction intercepts a peripheral region of the electrode structure or a region that is outside the electrode structure such as a region F. The region F collocates or co-locates with the electrode structure (3, 1) in the matrix (500a), for example, the region F is located at a center region of the electrode structure (3, 1) in the matrix (500a). Thus, when the gaze direction intercepts the region F, the corresponding electrode structure (3, 1) in the matrix (500a) can be activated.

The TLCL matrix (e.g., (500), (900), or (1100)) can be used in wearable applications, such as in a head mounted display (HMD) system. An HMD system can include LC prescription (Rx) glasses (also referred to as an LC Rx eye piece), AR glasses, and/or the like. In some examples, the HMD system also includes an eye tracking device that is configured to determine a gaze direction of an eye and a controller that is configured to determine and apply voltages to drive a single TLCL structure in the TLCL matrix such that a single TLCL is formed based on the TLCL structure driven by the voltages.

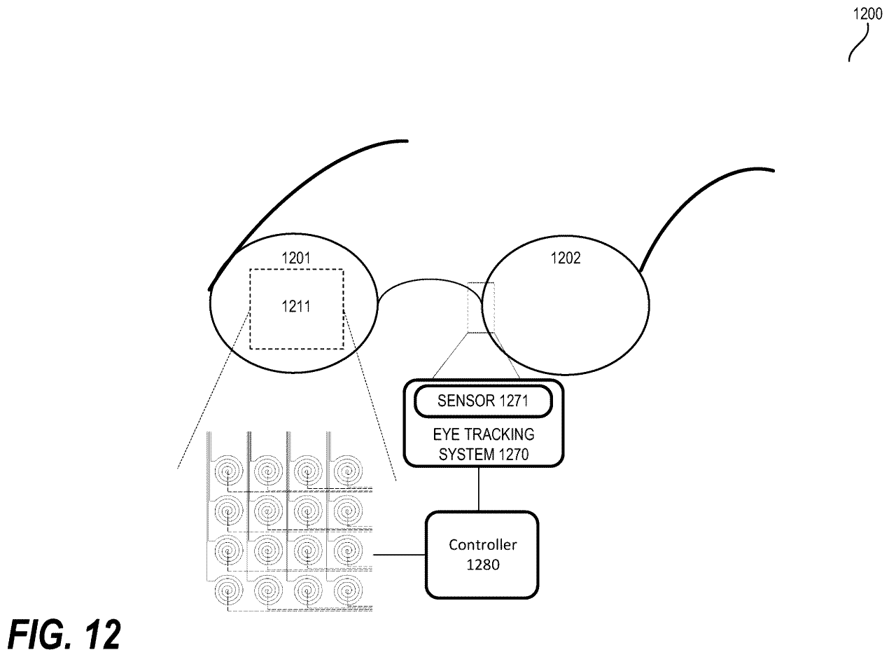

FIG. 12 shows an example of an LC Rx glasses (1200) including two eye pieces (1201) and (1202). Each eye piece can include a TLCL matrix, such as the matrix (500), (900), (1100), or the like. FIG. 12 shows an enlarged view of an area (1211) on the eye piece (1201), and the area (1211) includes a portion of the matrix. In an example, with an eye tracking technique, the eye-glasses (1200) that include the TLCL matrices can perform foveal vision correction, e.g., for compensating myopia (nearsightedness), hyperopia (farsightedness), astigmatism, coma, and the like under different driving voltages. In an example, astigmatism results from an irregularly shaped cornea or lens, causing light to focus unevenly and leading to blurry or distorted vision at any distance. In an example, coma refers to a type of optical aberration where rays from an off-axis point of light create a trailing comet-like blur, which may lead to smearing or a comet-shaped appearance of images.

The gaze direction can be determined using any suitable method and by any suitable apparatus or system. The LC Rx glasses (1200) can include an eye tracking system (1270) that is configured to determine a gaze direction (e.g., an eye looks in the gaze direction) of an eye of the user of the LC Rx glasses (1200). The eye tracking system (1270) can determine the gaze direction of the eye using (i) optical methods and optical components and/or (ii) non-optical methods and non-optical components. The eye tracking system (1270) can include a sensor (1271) such as a camera (e.g., an infrared camera) that can detect or obtain information such as eye movement, eye positions, and/or the like that can indicate the gaze direction. In an example, light, including infrared light, is reflected from the eye and sensed by the sensor (1271) such as a camera. The information can be analyzed to extract eye rotation from changes in reflections. Video-based eye trackers can use (i) the corneal reflection and the center of the pupil as features to track over time; (ii) reflections from the front of the cornea and the back of the lens as features to track; and/or the like and can determine the gaze direction. In an example, features from inside the eye such as the retinal blood vessels can be imaged and followed as the eye rotates, and the gaze direction can be determined. The eye tracking system (1270) and/or a controller (1280) can determine the gaze direction. The controller (1280) can be configured to determine which TLCL structure (e.g., (510) or (910)) in the TLCL matrix (e.g., (500) or (900)) is to be used to form the respective LC lens, for example, based on the gaze direction. The positions of the LC lenses formed in the TLCL matrix can vary with the gaze directions. The positions of the LC lenses can be determined based on the gaze directions.

Referring to FIG. 12, the eye tracking system (1270) is disposed on a portion of LC Rx glasses (1200). In an example, the eye tracking system (1270) is attached or otherwise mounted on the LC Rx glasses (1200). The eye tracking system (1270) can be positioned at any suitable location or multiple locations on the LC Rx glasses (1200). Referring to FIG. 12, various components (e.g., the controller (1280), the eye tracking system (1270), and/or the like) in the LC Rx glasses (1200) can communicate using any suitable methods, such as wireless, wired, optical, and/or the like. Alternatively, the eye tracking system (1270) can be physically separated from the LC Rx glasses (1200), and can communicate with the LC Rx glasses (1200) and/or the controller (1280) using any suitable method such as described above.

In an example, the TLCL component or matrix is used in VR or AR pancake lenses to provide vergence-accommodation conflict (VAC) solutions, which can mitigate the VAC, a common optical challenge in AR systems caused by mismatches between vergence (eye convergence) and accommodation (lens focusing).

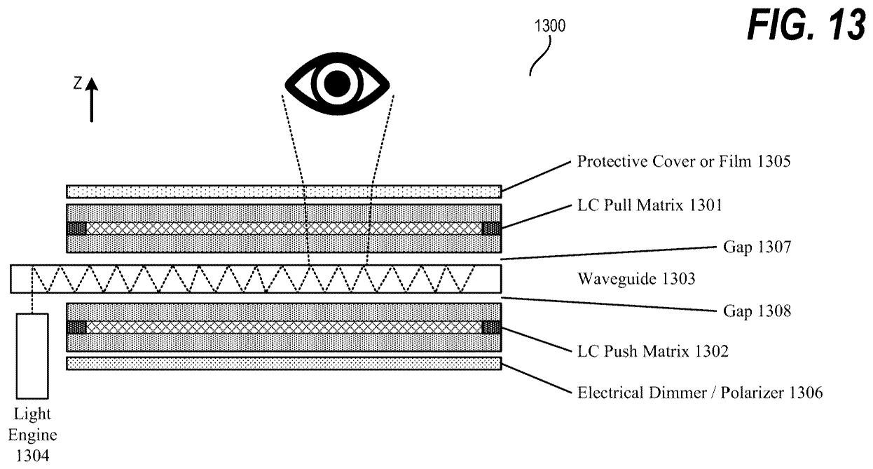

In an example, an HMD system includes an AR eyepiece, such as shown in FIG. 13. FIG. 13 shows an example of a portion of an AR glass or an AR eye piece (1300). The AR glass can include LC matrices (1301)-(1302), an optical waveguide (1303) that is disposed between the LC matrices (1301)-(1302), a light engine (1304), and/or the like. The optical waveguide (1303) is configured to direct light from the light engine (1304) to an eye of a user.

Each of the LC matrices (1301)-(1302) can be (i) the matrix (500), (ii) (900), (iii) (1100), or (iv) a variation of the matrix (500), (900), or (1100). Each of the LC matrices (1301)-(1302) can include a plurality of TLCL structures (e.g., (510)). As described above, each TLCL structure is configured to be electrically isolated from remaining TLCL structures in the plurality of TLCL structures. Thus, each TLCL structure is configured to be driven separately from the remaining TLCL structures, and a single LC lens can be formed from one of the plurality of TLCL structures (e.g., (510)) by applying suitable voltages to the one of the plurality of TLCL structures (e.g., (510)) and there is no or minimal crosstalk with remaining TLCL structures.

The LC matrix (1301) can be referred to as an LC Pull matrix and is positioned closer to the eye than the LC matrix (1302). The LC matrix (1302) can be referred to as an LC Push matrix and is positioned further to the eye than the LC matrix (1301).

During operation, light from the light engine (1304) can be directed by the optical waveguide (1303), and a virtual image can be generated by the optical waveguide (1303), for example, initially perceived at infinity by the eye.

In an example, a single lens is formed from one of the plurality of TLCL structures in the LC Pull matrix (1301), and the single lens is referred to as an LC Pull lens. The LC Pull lens can be configured to shift the virtual image generated by the optical waveguide (1303) into an optimal viewing zone for comfortable long-term use. The LC Pull lens can have a first optical power. In an example, the first optical power is negative, e.g., a negative diopter. Complementing this, the LC Push matrix (1302) is configured to counterbalance the optical effect of LC pull lenses in the LC Pull matrix (1301).

In an example, a single lens is formed from one of the plurality of TLCL structures in the LC Push matrix (1302), and the single lens is referred to as an LC Push lens. In an example, the LC Push lens has a second optical power that is determined based on (i) the first optical power and (ii) a vision correction for the eye (e.g., an amount of nearsightedness or farsightedness of the eye). In an example, when the eye has no or omittable vision impairment, the second optical power is positive, e.g., a positive diopter, and a sum of the first optical power and the second optical power is zero or approximately zero. Thus, the AR eye piece (1300) is configured to enable a user without vision impairments to clearly perceive both virtual and real-world objects at a distance. For individuals with refractive errors such as myopia or presbyopia, the optical powers of the push and pull lenses can be determined to correct the specific vision impairments. Accordingly, the configuration of the AR eye piece (1300) can mitigate the VAC.

In some examples, the AR eye piece (1300) further includes a protective cover or film (1305), an electrical dimmer or polarizer (1306) that is configured to adjust or control an amount of light that goes into the eye. In an example, the LC Pull matrix (1301) and the waveguide (1303) are separated by a gap (1307) such as an air gap. In an example, the LC Push matrix (1302) and the waveguide (1303) are separated by a gap (1308) such as an air gap.

In an example, a thickness of the AR eye piece (1300) is relatively thin, such as less than or approximately equal to 2.5 mm. In an example, thicknesses of the components in the AR eye piece (1300) are measured along the Z axis. A thickness of the protective cover (1305) is approximately 0.2 mm, a thickness of the electrical dimmer (1306) is approximately 0.3 mm, a thickness of the LC Pull matrix (1301) is approximately 0.5 mm, a thickness of the waveguide (1303) is approximately 0.6 mm, a thickness of the gap (1307) is approximately 0.2 mm, a thickness of the LC Push matrix (1302) is approximately 0.5 mm, and a thickness of the gap (1308) is approximately 0.2 mm. In an example, the AR eye piece (1300) for an eye has a width of approximately 59 mm, and a height of approximately 41 mm where the width and the height are measured in directions that are approximately perpendicular to the Z axis. In an example, the light engine (1304) is integrated into the AR eye piece (1300). In an example, the light engine (1304) is separate from the AR eye piece (1300). The AR eye piece (1300) can be light-weight, such as less than 10 grams when the AR eye piece (1300) does not include the light engine (1304) and has dimensions described above. The AR eye piece (1300) can be configured to have a suitable focus range. In an example, the focus range is from −6D to 0. In an example, the focus range is from −6D to 3D. In an example, a transmission is larger than 60% without the electrical dimmer (1306). A field of view (FOV) can be larger than 30°. In an example, an eye-box is larger than 12×12 mm. In an example, the eye relief is larger than 15 mm.

The gaze direction can be determined using any suitable method and by any suitable apparatus or system such as described with reference to FIG. 12. In an example, the AR eye piece (1300) can include an eye tracking system similar or identical to the eye tracking system (1270) that is configured to determine a gaze direction of an eye of the user of the AR eye piece (1300). A controller similar or identical to the controller (1280) can be configured to determine which TLCL structure in the TLCL matrix (1301) and which TLCL structure in the TLCL matrix (1302) are to be used to form the respective LC lenses, for example, based on the gaze direction. The positions of the LC lenses formed in the TLCL matrices (1301)-(1302) can vary with the gaze directions. The positions of the LC lenses can be determined based on the gaze directions.

The eye tracking system can be positioned at any suitable location(s) on the AR eye piece (1300). Alternatively, the eye tracking system can be physically separate from the AR eye piece (1300), and can communicate with the AR eye piece (1300) and/or the controller using any suitable method such as described with reference to FIG. 12.

Integrating the tunable foveal LC lens matrix technology can enable electronic control over lens diopters. The TLCL matrix technology can allow dynamic adjustment of optical power to simultaneously correct VAC and individual vision conditions, such as myopia or presbyopia, mitigating or even eliminating mechanical lens adjustments. Consequently, this approach can significantly enhance user comfort and visual performance in AR applications.

Aspects in the disclosure may be used separately or combined in any order.

While this disclosure has described several exemplary aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A liquid crystal (LC) device, comprising:
a first LC structure matrix that includes:
a first substrate,
a first structure including:
a first conductive layer disposed on the first substrate, the first conductive layer being transparent and including first control electrodes,
a dielectric layer disposed on the first conductive layer, and
a plurality of electrode structures disposed on the dielectric layer, each of the plurality of electrode structures including (i) a first contact point that is electrically coupled with a respective first control electrode of the first control electrodes and (ii) a second contact point that is electrically coupled with a respective second control electrode that is disposed over the dielectric layer, and
an LC layer including an LC material between the plurality of electrode structures of the first structure and a second conductive layer that is disposed between a second substrate of the first LC structure matrix and the first structure, wherein
a first LC lens corresponding to a first one of the plurality of electrode structures is formed when
a first voltage is applied between (i) the first control electrode that is electrically coupled with the first contact point of the first one of the plurality of electrode structures and (ii) the second conductive layer, and
a second voltage is applied between (i) the second control electrode that is electrically coupled with the second contact point of the first one of the plurality of electrode structures and (ii) the second conductive layer.

2. The LC device according to claim 1, wherein the first contact point of each of the plurality of electrode structures that is disposed on the dielectric layer is electrically coupled with the respective first control electrode of the first control electrodes through a conductive material disposed in a via in the dielectric layer.

3. The LC device according to claim 1, wherein the plurality of electrode structures is arranged on the dielectric layer in a two-dimensional matrix.

4. The LC device according to claim 1, wherein each electrode structure of the plurality of electrode structures is configured to be driven separately from other electrode structures of the plurality of electrode structures.

5. The LC device according to claim 1, wherein
each first control electrode in the first control electrodes is electrically isolated from other first control electrodes in the first control electrodes,
each second control electrode in the second control electrodes is electrically isolated from other second control electrodes in the second control electrodes, and
each electrode structure of the plurality of electrode structures is electrically isolated from other electrode structures of the plurality of electrode structures.

6. The LC device according to claim 1, wherein
a second LC lens corresponding to a second one of the plurality of electrode structures that is different from the first LC lens is formed when
a third voltage is applied between (i) the first control electrode that is electrically coupled with the first contact point of the second one of the plurality of electrode structures and (ii) the second conductive layer, and
a fourth voltage is applied between (i) the second control electrode that is electrically coupled with the second contact point of the second one of the plurality of electrode structures and (ii) the second conductive layer.

7. The LC device according to claim 1, further comprising:
a second LC structure matrix that includes:
a third substrate,
a second structure including:
a third conductive layer disposed on the third substrate, the third conductive layer being transparent and including third control electrodes,
a second dielectric layer disposed on the third conductive layer, and
a second plurality of electrode structures disposed on the second dielectric layer, each of the second plurality of electrode structures including (i) a third contact point that is electrically coupled with a respective third control electrode of the third control electrodes and (ii) a fourth contact point that is electrically coupled with a respective fourth control electrode that is disposed over the second dielectric layer, and
a second LC layer including a second LC material between the second plurality of electrode structures of the second structure and a fourth conductive layer that is disposed between a fourth substrate of the second LC structure matrix and the second structure, wherein
a second LC lens corresponding to a first one of the second plurality of electrode structures is formed when
a third voltage is applied between (i) the third control electrode that is electrically coupled with the third contact point of the first one of the second plurality of electrode structures and (ii) the fourth conductive layer, and
a fourth voltage is applied between (i) the fourth control electrode that is electrically coupled with the fourth contact point of the first one of the second plurality of electrode structures and (ii) the fourth conductive layer, the second LC structure matrix being disposed over the first LC structure matrix along a direction that is substantially perpendicular to the first substrate of the first LC structure matrix.

8. The LC device according to claim 7, wherein the second LC structure matrix and the first LC structure matrix are offset along a direction within the first substrate of the first LC structure matrix.

9. The LC device according to claim 1, wherein the first one of the plurality of electrode structures has a spiral shape, the first contact point of the first one of the plurality of electrode structures is in a central region of the spiral shape, and the second contact point of the first one of the plurality of electrode structures is in a peripheral region of the spiral shape.

10. The LC device according to claim 1, wherein the first one of the plurality of electrode structures has a spiral shape, the first contact point and the second contact point of the first one of the plurality of electrode structures at ends of the spiral shape are in peripheral regions of the spiral shape.

11. The LC device according to claim 1, wherein
the first conductive layer includes a metal layer; and
the plurality of electrode structures and the second conductive layer include indium tin oxide (ITO).

12. The LC device according to claim 1, wherein the first LC lens is formed when
in addition to applying the first voltage and the second voltage,
a zero voltage is applied between each remaining first control electrode and the second conductive layer, and
a zero voltage is applied between each remaining second control electrode and the second conductive layer.

13. A head mounted display (HMD) system, comprising:
a plurality of liquid crystal (LC) devices, wherein
each of the plurality of LC devices includes:
a first substrate,
a first structure including:
a first conductive layer disposed on the first substrate, the first conductive layer being transparent and including first control electrodes,
a dielectric layer disposed on the first conductive layer, and
a plurality of electrode structures disposed on the dielectric layer, each of the plurality of electrode structures including (i) a first contact point that is electrically coupled with a respective first control electrode of the first control electrodes and (ii) a second contact point that is electrically coupled with a respective second control electrode that is disposed over the dielectric layer, and
an LC layer including an LC material between the plurality of electrode structures of the first structure and a second conductive layer that is disposed between a second substrate of the respective LC device and the first structure, and
an LC lens corresponding to one of the plurality of electrode structures is formed when
a first voltage is applied between (i) the first control electrode that is electrically coupled with the first contact point of the one of the plurality of electrode structures and (ii) the second conductive layer, and
a second voltage is applied between (i) the second control electrode that is electrically coupled with the second contact point of the one of the plurality of electrode structures and (ii) the second conductive layer.

14. The HMD system according to claim 13, wherein
the HMD system includes an augmented reality (AR) eyepiece,
the AR eyepiece includes:
a waveguide that is configured to direct light from a light engine to an eye of a user, a first one of the plurality of LC devices that is disposed between the eye of the user and the waveguide,
a second one of the plurality of LC devices, the waveguide being disposed between the first one of the plurality of LC devices and the second one of the plurality of LC devices,
a first lens corresponding to one of the plurality of electrode structures in the first one of the plurality of LC devices has a first optical power that is negative,
a second lens corresponding to one of the plurality of electrode structures in the second one of the plurality of LC devices has a second optical power, the second optical power being determined based on (i) the first optical power and (ii) an amount of nearsightedness or farsightedness of the user.

15. The HMD system according to claim 13,
the HMD system includes a prescription eyepiece including one of the plurality of LC devices that is disposed on the prescription eyepiece, a lens corresponding to one of the plurality of electrode structures in the one of the plurality of LC devices has an optical power that is based on an amount of nearsightedness or farsightedness of a user of the prescription eyepiece.

16. The HMD system according to claim 13, wherein the first contact point of each of the plurality of electrode structures that is disposed on the dielectric layer is electrically coupled with the respective first control electrode of the first control electrodes through a conductive material disposed in a via in the dielectric layer.

17. The HMD system according to claim 13, wherein the plurality of electrode structures is arranged on the dielectric layer in a two-dimensional matrix.

18. The HMD system according to claim 13, wherein each electrode structure of the plurality of electrode structures is configured to be driven separately from other electrode structures of the plurality of electrode structures.

19. The HMD system according to claim 13, wherein
each first control electrode in the first control electrodes is electrically isolated from other first control electrodes in the first control electrodes,
each second control electrode in the second control electrodes is electrically isolated from other second control electrodes in the second control electrodes, and
each electrode structure of the plurality of electrode structures is electrically isolated from other electrode structures of the plurality of electrode structures.

20. The HMD system according to claim 13, wherein the LC lens is formed when
in addition to applying the first voltage and the second voltage,
a zero voltage is applied between each remaining first control electrode and the second conductive layer, and
a zero voltage is applied between each remaining second control electrode and the second conductive layer.
